(19) United States
(12) Patent Application Publication
(10) Pub. No.: US 2026/0073262 A1
(43) Pub. Date: Mar. 12, 2026

(54) ULTRAFAST GATES VIA STATE DEPENDENT KICKS AND FAST DISPLACEMENTS

(71) Applicant: IonQ, Inc., College Park, MD (US)

(72) Inventor: Jonathan MIZRAHI, Silver Spring, MD (US)

(21) Appl. No.: 18/811,554

(22) Filed: Aug. 21, 2024

Related U.S. Application Data
(60) Provisional application No. 63/578,510, filed on Aug. 24, 2023.

(51) Int. Cl. G06N 10/20

(52) U.S. Cl. CPC G06N 10/20

(57) ABSTRACT

Aspects of the disclosure provides systems and methods for quantum information processing (QIP). A method for QIP includes performing a first state dependent kick (SDK) to a trapped ion in an ion trap having a first trapping potential. The trapped ion is in a first spin state prior to the first SDK. The first SDK includes a first momentum kick to the trapped ion that depends on the first spin state. The first SDK is associated with a spin flip from the first spin state into a second spin state. A duration of the first SDK is less than a trap period Ttrap of the first trapped ion. The method includes changing a first trapping potential of the ion trap to a second trapping potential of the ion trap to amplify a phase associated with a current spin state of the first trapped ion.

### CROSS REFERENCE TO RELATED APPLICATIONS

The current application claims priority to U.S. Patent Provisional Application No. 63/578,510, filed Aug. 24, 2023, the entire contents of which are hereby incorporated by reference.

### TECHNICAL FIELD

Aspects of the present disclosure relate generally to systems and methods for use in the implementation and/or operation of quantum information processing (QIP) systems, and more particularly, to operations of multiple QIP systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In some aspects of the present disclosure, a method for quantum information processing (QIP) can include performing a first state dependent kick (SDK) (e.g., a first spin-dependent kick) to a first trapped ion in an ion trap having a first trapping potential. The first trapped ion can be in a first spin state and a first motional state prior to the first SDK. The first SDK can include a first momentum kick to the first trapped ion that depends on the first spin state and is associated with a spin flip from the first spin state into a second spin state. A duration of the first SDK can be less than a trap period Ttrap of the trapped ion. The method can include changing a first trapping potential of the ion trap to a second trapping potential of the ion trap to amplify a phase associated with a current spin state of the first trapped ion. In an example, the phase is dependent on a size of the first momentum kick and the changing of the first trapping potential to the second trapping potential, and the current spin state is one of the first spin state and the second spin state

In an example, the changing the first trapping potential includes changing a first equilibrium position c10 of the first trapped ion in the first trapping potential to a second equilibrium position c11 of the first trapped ion in the second trapping potential. The phase associated with the current spin state of the first trapped ion is amplified by a displacement between the first equilibrium position c10 and the second equilibrium position c11.

In an example, the method includes providing a first delay T1 between the first SDK and the changing of the first trapping potential, and the first SDK is performed prior to the changing of the first trapping potential.

In an example, after changing the first trapping potential to the second trapping potential, the method includes performing a second SDK on the first trapped ion. The second SDK includes a second momentum kick to the first trapped ion that is opposite to the first momentum kick and is associated with a spin flip from the second spin state into the first spin state. A duration of the second SDK is less than the trap period Ttrap, and a second delay T2 is between the second SDK and the changing of the first trapping potential.

In an example, the method includes changing the second trapping potential of the ion trap to the first trapping potential of the ion trap where a third delay T3 is between the second SDK and the changing of the second trapping potential.

In an example, at least one of (i) a duration of changing the first trapping potential to the second trapping potential and (ii) a duration of changing the second trapping potential to the first trapping potential are less than the trap period Ttrap of the first trapped ion.

In an example, the performing the first SDK includes applying one or more first pairs of optical pulses to the first trapped ion. Each pair of optical pulses includes two counterpropagating pulses arriving at the first trapped ion, and spectral components of the two counterpropagating pulses are separated by a frequency difference based on energy levels of the first spin state and the second spin state.

In an example, the one or more first pairs of optical pulses include only one pair of optical pulses, and a respective pulse area of each optical pulse is π.

In an example, the one or more first pairs of optical pulses include N0 pairs of optical pulses, and a respective pulse area of each optical pulse is π.

In an example, the one or more first pairs of optical pulses include N0 pairs of optical pulses, and a total pulse area of N0 optical pulses in the respective N0 pairs of optical pulses is π.

In an example, the first trapped ion is a Ytterbium (171Yb+) ion, the first spin state and the second spin state correspond to two hyperfine levels |0> and |1> of a 2S1/2 ground manifold of the 171Yb+ ion, and each pair of optical pulses drives a stimulated Raman transition between the two hyperfine levels |0> and |1>.

In an example, the performing the first SDK includes applying one or more optical pulses to the first trapped ion. Each optical pulse resonantly drives the first trapped ion from the first spin state to the second spin state.

In an example, the changing of the first trapping potential includes manipulating voltages at electrodes of the ion trap.

In an example, the method includes performing a first SDK to a second trapped ion in the ion trap having the first trapping potential. The second trapped ion is in a first spin state and a first motional state prior to the first SDK to the second trapped ion. The first SDK to the second trapped ion includes a first momentum kick to the second trapped ion that depends on the first spin state of the second trapped ion and is associated with a spin flip from the first spin state of the second trapped ion into a second spin state of the second trapped ion.

In an example, the changing of the first trapping potential further comprises increasing a trapping frequency.

Aspects of the present disclosure includes systems and methods for QIP. The QIP system includes an array of trapped ions including a first trapped ion, an optical system configured to generate pairs of optical pulses, an ion trap configured to trap the first trapped ion, and a controller. The trapping potential of the ion trap may be switchable between a first trapping potential and a second trapping potential. The controller for controlling operations of the optical system and the ion trap is configured to control the optical system to perform a first state dependent kick (SDK) to the first trapped ion that is in a first spin state and a first motional state prior to the first SDK. The first SDK includes a first momentum kick to the first trapped ion that depends on the first spin state and is associated with a spin flip from the first spin state into a second spin state. A duration of the first SDK is less than a trap period Ttrap of the first trapped ion. The controller is configured to switch the first trapping potential of the ion trap to the second trapping potential of the ion trap. A phase associated with a current spin state of the first trapped ion is amplified by changing the first trapping potential of the ion trap to the second trapping potential of the ion trap, the phase is dependent on a size of the first momentum kick and the changing of the first trapping potential to the second trapping potential, and the current spin state is one of the first spin state and the second spin state.

In an example, the controller is configured to change a first equilibrium position c10 of the first trapped ion in the first trapping potential to a second equilibrium position c11 of the first trapped ion in the second trapping potential. The phase associated with the current spin state of the first trapped ion is amplified by a displacement between the first equilibrium position c10 and the second equilibrium position c11.

In an example, after switching the first trapping potential to the second trapping potential, the controller is configured to cause the optical system to perform a second SDK on the first trapped ion. The second SDK includes a second momentum kick to the first trapped ion that is opposite to the first momentum kick and is associated with a spin flip from the second spin state into the first spin state. A duration of the second SDK is less than the trap period Ttrap, a first delay T1 is between the first SDK and the changing of the first trapping potential, and a second delay T2 is between the second SDK and the switching of the first trapping potential to the second trapping potential.

In an example, the controller is configured to cause the second trapping potential of the ion trap being switched to the first trapping potential of the ion trap. A third delay T3 is between the second SDK and the changing of the second trapping potential.

In an example, the controller is configured to performing a first SDK to a second trapped ion in the ion trap having the first trapping potential. The second trapped ion is in a first spin state and a first motional state prior to the first SDK to the second trapped ion. The first SDK to the second trapped ion includes a first momentum kick to the second trapped ion that depends on the first spin state of the second trapped ion and is associated with a spin flip from the first spin state of the second trapped ion into a second spin state of the second trapped ion.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of the present disclosure.

FIG. 2 illustrates an example of a quantum information processing (QIP) system in accordance with aspects of the present disclosure.

FIG. 3 illustrates an example of a computer device in accordance with aspects of the present disclosure.

FIG. 4 shows an example of states (or qubit states) of a trapped ion in an array of trapped ions of a QPU according to an embodiment of the present disclosure.

FIG. 5 shows an exemplary QIP system according to an embodiment of the present disclosure.

FIG. 6 shows an exemplary time sequence of state dependent kicks (SDKs) and manipulations of a trapping potential according to an embodiment of the disclosure.

FIG. 7 shows an exemplary phase space path of a trapped ion for the sequence shown in FIG. 6 according to an embodiment of the disclosure.

FIG. 8 shows an exemplary optical pulses and ion trap control timing schematics according to an embodiment of the disclosure.

FIG. 9 shows an exemplary optical pulses and ion trap control timing schematics according to an embodiment of the disclosure.

FIG. 10 shows a method for combining qubit state dependent kick(s) and manipulation(s) of a trapping potential of a trapped ion according to an embodiment of the present disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Quantum computing includes methods for processing information that utilizes quantum two-level systems or quantum bits (qubits) as the fundamental unit of information storage. Quantum computing can further leverage entanglement between qubits, natively generated in quantum computing C platforms, to perform computations with fewer resources (e.g., computation time, number of bits, etc.) than classical computing schemes. A state dependent kick (SDK) or a qubit state dependent kick (e.g., a spin dependent kick) can refer to a momentum kick to a trapped ion that depend on the qubit state (e.g., a qubit spin state) of the trapped ion. A qubit state dependent kick (e.g., a spin dependent kick) can allow fast two ion entangling gates. However, entangling gates implemented using SDKs alone face a number of problems, for example, in terms of a gate speed and gate fidelity. For example, a large number of kicks are to be combined to achieve a gate due to a relatively small SDK size (or SDK magnitude) η in each SDK (e.g., a spin dependent kick), and thus limiting a gate speed. Further, combining effects of multiple SDKs or spin dependent kicks may be challenging. Spontaneous emission can limit the highest achievable fidelity of a single SDK, and thus limiting fidelity of the gate. The SDKs are discretized, and thus setting the phase to create a maximally entangling gate may be challenging.

Exemplary embodiments of the present disclosure include a controller (e.g., including both hardware and software) configured to combine and control a manipulation (e.g., a fast manipulation) of a trapping potential with qubit state dependent kicks (e.g., spin dependent kicks). The manipulation of the trapping potential can include switching the trapping potential between a first trapping potential and a second trapping potential, and thus can displace first equilibrium positions of trapped ions in the first trapping potential to respective second equilibrium positions of the trapped ions in the second trapping potential. With a suitable sequence of the SDKs (e.g., spin dependent kicks) combined with the manipulations of the trapping potential, the phase acquired after implementing the sequence can be dependent on the SDK (e.g., spin dependent kick) size η and an amplification factor where the amplification factor depends on the displacements. In an example, a first equilibrium position c10 of a trapped ion in the first trapping potential is displaced to a second equilibrium position c11 in the second trapping potential, and the phase is proportional to η and the displacement, and thus is amplified by a factor of (c11-c10). The above problems can be mitigated (e.g., significantly mitigated) by combining a manipulation (e.g., a fast manipulation) of a trapping potential with qubit state dependent kicks (e.g., spin dependent kicks), and a relatively fast gate (e.g., an ultrafast gate) can be achieved.

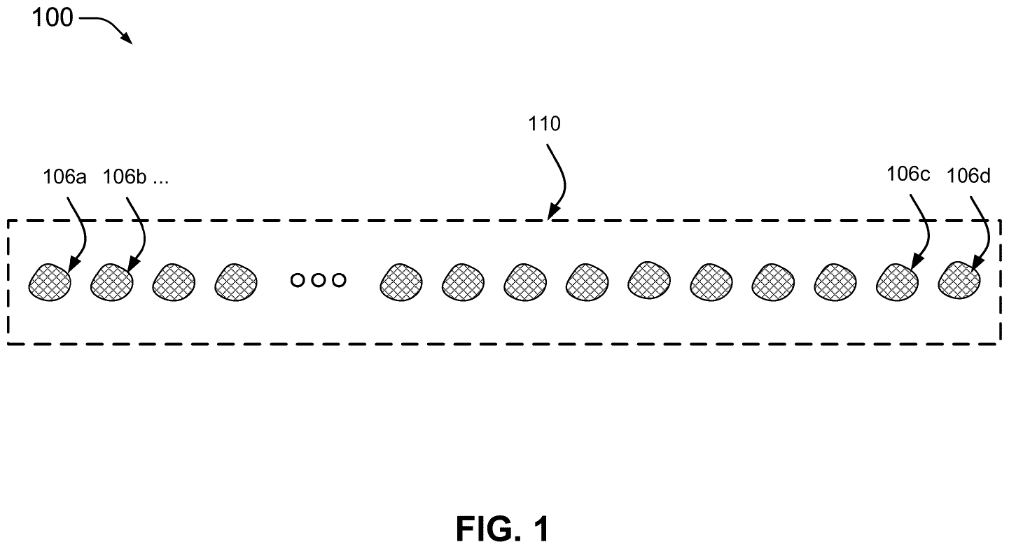

Solutions to the issues described above are explained in more detail in connection with FIGS. 1-10, with FIGS. 1-3 providing a general configuration of QIP systems or quantum computers, and more specifically, of atomic-based QIP systems or quantum computers.

Atomic quantum computers can include array(s) of atoms or ions trapped, for example, inside a vacuum chamber. A size and dimensionality of atomic arrays may vary.

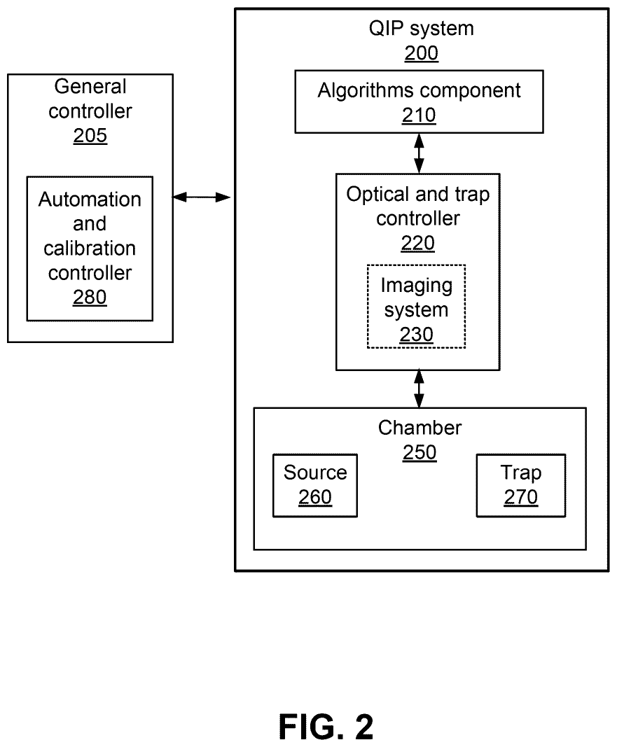

FIG. 1 illustrates a diagram 100 with multiple atomic ions 106 (e.g., atomic ions 106a, 106b, . . . , 106c, and 106d) trapped in a linear crystal or chain 110 using a trap. In an example, the trap can be inside a vacuum chamber as shown in FIG. 2. The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110. The multiple atomic ions can be laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), barium ions, for example. The atomic ions are illuminated with laser (optical) radiation tuned to a resonance in ¹⁷¹Yb⁺ and the fluorescence of the atomic ions is imaged onto a camera or some other type of detection device. Any suitable separation between atomic ions in a single cluster can be used. The separations can be uniform or non-uniform. A separation between atomic ions in a single cluster may range from 1 to 10 microns (μm). In an example, atomic ions may be separated by about 5 μm from each other, although the separation may be smaller or larger than 5 μm. The separation of the atomic ions is determined by a balance between the external confinement force and Coulomb repulsion and does not need to be uniform. In addition to atomic Ytterbium ions, neutral atoms, Rydberg atoms, different atomic ions or different species of atomic ions may be used. The trap may be a linear radiofrequency (RF) Paul trap. Other types of confinement may also be used, including optical confinements. Thus, a confinement device may be based on different techniques and may hold ions and/or neutral atoms, for example, with an ion trap being one example of such a confinement device. The ion trap may be a surface trap, for example.

FIG. 2 shows a block diagram that illustrates an example of a QIP system 200 in accordance with various aspects of this disclosure. The QIP system 200 may be referred to as a quantum computing system, a quantum computer, a computer device, a trapped ion system, or the like. The QIP system 200 may be part of a hybrid computing system in which the QIP system 200 is used to perform quantum computations and operations. The hybrid computing system can include a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. In an example, the lasers and optical systems is at least partially located in the optical and trap controller 220 and/or in the chamber 250. For example, optical systems within the chamber 250 may be referred to as optical components or optical assemblies.

The QIP system 200 may include an imaging system 230. The imaging system 230 may include a high-resolution imager (e.g., CCD camera) or other type of detection device (e.g., a photomultiplier tube or a PMT) for monitoring the atomic ions while the atomic ions are being provided to the trap 270 and/or after the atomic ions have been provided to the trap 270. In an embodiment, the imaging system 230 can be implemented separately from the optical and trap controller 220. In an embodiment, the use of fluorescence to detect, identify, and label atomic ions using image processing algorithms may be coordinated with the optical and trap controller 220.

The QIP system 200 can include a source 260 that can provide atomic species (e.g., a plume or flux of neutral atoms) to the chamber 250 having the trap 270. When atomic ions are the basis of the quantum operations, the trap 270 can confine the atomic species when the atomic species are ionized (e.g., photoionized). The trap 270 may be part of a processor or processing portion of the QIP system 200. For example, the trap 270 may be considered as the core of the processing operations of the QIP system 200 since the trap 270 holds the atomic-based qubits that are used to perform the quantum operations or simulations. In an example, at least a portion of the source 260 may be implemented separately from the chamber 250.

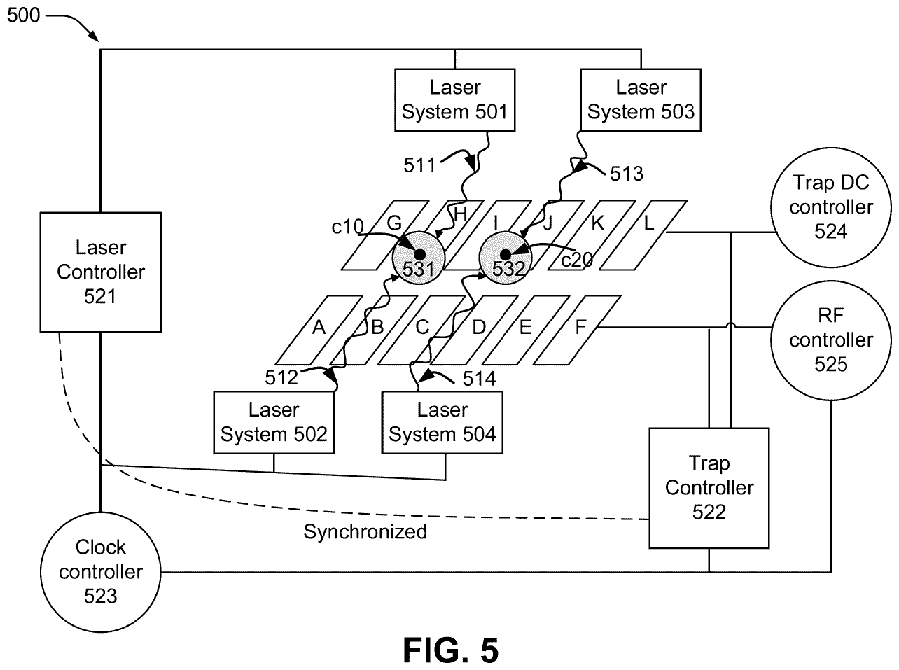

It is to be understood that the various components of the QIP system 200 described in FIG. 2 are described at a high-level for ease of understanding. Such components may include one or more sub-components, the details of which may be provided below (e.g., FIG. 5) as needed to better understand certain aspects of this disclosure.

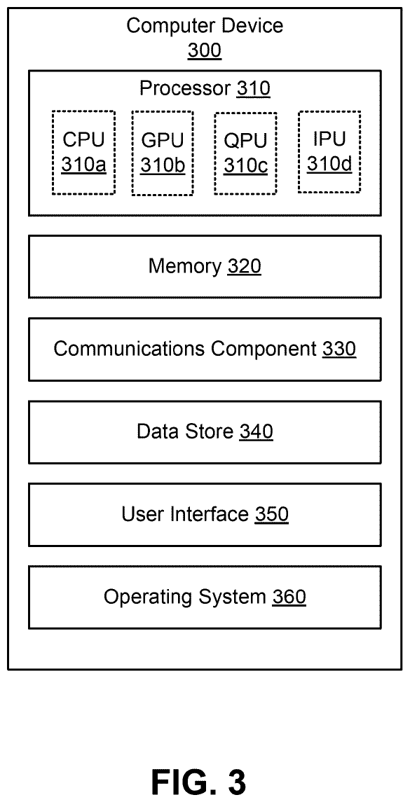

FIG. 3 shows an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2 or a QIP system 500 shown in FIG. 5.

The computer device 300 may include a processor 310 for carrying out processing functions associated with one or more of the features described herein. The processor 310 may include a single or multiple set of processors or multi-core processors. The processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence (AI) processors), or a combination of some or all those types of processors. In one aspect, the processor 310 may be referred to as a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may store data for processing by the processor 310 and/or data resulting from processing by the processor 310. In an implementation, for example, the memory 320 may correspond to a computer-readable storage medium (e.g., a non-transitory computer-readable medium) that stores code or instructions to perform one or more functions or operations. The memory 320 may be referred to as a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

The computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

The computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., a classical OS, or a quantum OS, or both). In one implementation, the data store 340 may include the memory 320. In an implementation, the processor 310 may execute the operating system 360 and/or applications or programs, and the memory 320 or the data store 340 may store the operating system 360 and/or applications or programs.

The computer device 300 may include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, aspects of the present disclosure include a QIP system configured to combine and control a manipulation (e.g., a fast manipulation) of a trapping potential with qubit state dependent kicks (e.g., spin dependent kicks). The systems described in FIGS. 2, 3, and/or 5 may be used to control various aspects of the QIP system as described below.

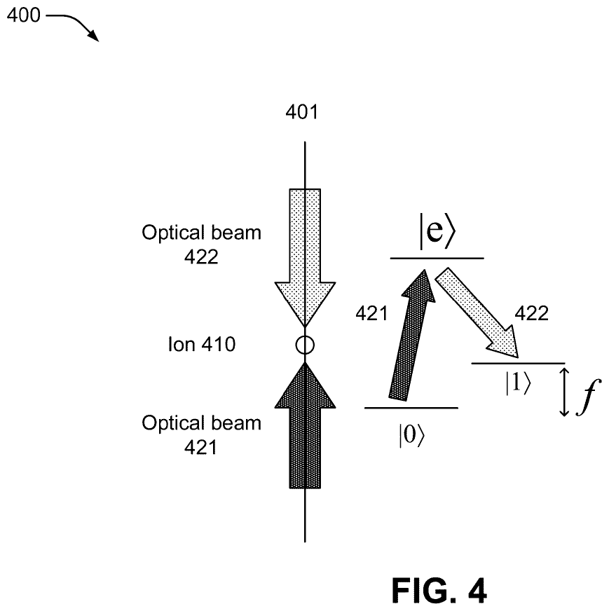

FIG. 4 shows an example of states (referred to as qubit states) of a trapped ion 410 in an array of trapped ions of a QPU or a QIP according to an embodiment of the present disclosure. The array of trapped ions can include any suitable number of trapped ions in any suitable arrangement, such as in a linear arrangement (e.g., the chain 110 in FIG. 1), in a two-dimensional (2D) arrangement, or the like. In an embodiment, two energy levels of the trapped ion 410 may be allocated to be the qubit states including a “zero” qubit state (indicated by |0> or |↓>) and a “one” qubit state (indicated by |1> or |↑>) of a qubit. An energy difference between |0> and |1> can be indicated by a frequency f, for example, the energy difference is proportional to the frequency f.

Light at certain optical frequencies can be used to drive a single qubit gate and multi-qubit gates. The light can be focused to a beam size, for example, that is less than a distance between trapped ions, and thus individually addressing qubits.

A qubit state-motion entanglement can be generated, for example, using optical pulses. A first qubit state (e.g., |0>) can be flipped into a second qubit state (e.g., |1>) by the optical pulses while the trapped ion 410 receives a momentum kick from the optical pulses. A direction of the momentum kick can be dependent on a qubit state (e.g., |0> or |1>). A first direction of a momentum kick associated with a qubit state flip from |0> to |1> can be different from a second direction of a momentum kick associated with a qubit state flip from | 1> to |0>. In an example the first direction is opposite to the second direction. The momentum kick described above can be referred to as a qubit state dependent kick. In an example, a direction (or a sign) of a momentum kick can also be affected or set by a wave-vector of an optical pulse. For example, in addition to the state dependent direction (or sign), the trapped ion 410 can also have the direction (or the sign) which is set by the wave-vector of the pulse used to drive the SDK. The two states can still receive kicks of opposite directions. In an example, the SDK has a vector direction which is equal to a sum (or a difference depending on the transition) of the wavevectors of the optical pulses driving the interaction due to the conservation of momentum, and the interactions with the optical pulses can cause the transfer of momentum.

A duration of a qubit state dependent kick can depend on (e.g., is equal to) a duration of the optical pulses. A duration of a qubit state dependent kick can be shorter than a trap period (also referred to as a trap oscillation period) T_{TRAP} (e.g., 1-10 microseconds (us)). A trap frequency f_{TRAP} can be proportional to 1/T_{TRAP}, e.g., f_{TRAP}=1/T_{TRAP}. A duration of a qubit state dependent kick can be much shorter than the trap period T_{TRAP}, for example, a duration of a qubit state dependent kick is less than or equal to T_{TRAP}/M where M is 10, 100, 1000, or the like. In an example, a qubit state dependent kick occurs in an interaction time of 1-10 nanosecond (ns) such as 2.7 ns, which is 0.2% of the 1.27 μs trap period.

In various embodiments, the two energy levels |0> and |1> can represent an effective spin ½ system, and the qubit states of the trapped ion 410 can be referred to as spin states. The “zero” qubit state |0> and the “one” qubit state |1> can be referred to as the “zero” spin state and the “one” spin state, respectively. A qubit level dependent kick can be referred to as a spin dependent kick when the qubit states are spin states.

In an example, the trapped ion is ¹⁷¹Yb⁺, and |0> and |1> correspond to two hyperfine levels (e.g., F=0 and F=1) in the ground state (²S_{1/2}) of ¹⁷¹Yb⁺. The parameter F can indicate a hyperfine level. For example, |0> and |1> are defined by the m_{F}=0 states of the ²S_{1/2} hyperfine manifold of ¹⁷¹Yb⁺: |0> is |F=0, m_{F}=0> and |1> is |F=1, m_{F}=0>, and the frequency f (indicated by f_{hf}) is 12.6 giga Hertz (GHz). The parameter m_{F} can indicate a sublevel in a hyperfine level. The trapped ion can be other suitable ions, such as barium ions.

Referring to FIG. 4, two optical beams (or optical pulses) 421-422 can counter propagate (e.g., propagate in opposite directions along an axis 401). The two optical beams 421-422 can overlap spatially. In an example, the two optical beams 421-422 arrive at the trapped ion 410 simultaneously. The two optical beams 421-422 can overlap (e.g., are synchronized) temporally. In an example, the two optical beams 421-422 partially overlap in the time domain with a temporal displacement. In an example, the optical and trap controller 220 is configured to generate (e.g., by an optical beam source such as a laser) and control the two optical beams 421-422 spatially and temporally. In an embodiment, transitions (or flips) between |0> and |1> are driven by stimulated Raman transitions, for example, using optical pulses. For example, in a stimulated Raman transition involving a virtual level |e>, the trapped ion 410 starts in |0>, and is driven to |1> by absorbing a first photon from the optical beam 421 and emitting a second photon into the optical beam 422, resulting in a momentum kick (e.g., an SDK) in a first direction (e.g., an upward direction). Similarly, the trapped ion 410 starts in |1>, and is driven to |0> by absorbing a photon from the optical beam 422 and emitting a photon into the optical beam 421, resulting in a momentum kick (e.g., an SDK) in a second direction (e.g., a downward direction). In an embodiment, the transitions between |0> and |1> are driven by a single pulse (e.g., a microwave (MW) pulse or an MW beam with a microwave wavelength) for a resonant transition (e.g., without the virtual level or the virtual state |e>). The state dependence for a single pulse (e.g., the MW pulse) can be the same as for a Raman transition with two optical pulses. In this case using the single pulse, the absorption of the photon (e.g., |0> to |1>) of the single pulse can take on a momentum of the photon (e.g., the MW photon) (e.g., a positive kick iηhk) where a stimulated emission of the photon (e.g., a MW photon) into the single pulse beam (e.g., the MW beam) (e.g., |1> to |0>) results in the momentum conservation requiring a kick in the opposite direction for the ion (e.g., a negative kick iηhk). k is the wavevector of the optical pulse. As described in FIG. 4, a qubit state dependent kick (e.g., a spin dependent kick) can be generated. When a duration T_{SDK} of a qubit state dependent kick is much smaller than the trap period T_{TRAP} (e.g., T_{SDK}≤T_{TRAP}/M where M is a pre-defined parameter such as 100), the qubit state dependent kick can occur nearly instantaneously relative to the trap period, and is referred to as an impulsive qubit state dependent kick.

A qubit state dependent kick (e.g., a spin dependent kick) can have the following action on a general state of a trapped ion (e.g., the trapped ion 410).

$$\vert 0 > \vert α > \to {e}^{i η Re [ α ]} \vert 1 > \vert α + i η > \qquad Eq . ( 1 )$$

$$\vert 1 > \vert α > \to {e}^{- i η Re [ α ]} \vert 0 > \vert α - i η > \qquad Eq . ( 2 )$$

where a general state |i>|α> represents a qubit state (e.g., a spin state) |i> (i being 0 or 1) and a motional state (or a coherent motional state) |α>. Referring to Eq. (1), for example, in an SDK (e.g., a spin dependent kick), the spin state |0> is flipped to the spin state |1>, a spin dependent phase term (also referred to as a spin dependent phase) e^{iηRe[α] is imparted by the SDK, and a coherent motional state |α> is changed to |α+iη>. Referring to Eq. (}2), for example, in an SDK, the spin state |1> is flipped to the spin state |0>, a spin dependent phase term e^{-iηRe[α] is imparted by the SDK, and a coherent motional state |α> is changed to |α-iη>. In an SDK described above, the spin states can receive respective displacements in phase space of ±iη. The parameter η can indicate a size (or a magnitude) of the qubit state dependent kick (e.g., an SDK). In an example, η indicates a coupling strength between internal states (e.g., spin states |}0> and |1>) and motional states (e.g., |α>) of an ion (e.g., the trapped ion 410). In an example, η is the Lamb-Dicke parameter.

Qubit state dependent kicks (e.g., spin dependent kicks) can allow fast two ion entangling gates that can operate faster than respective trap period(s) (e.g., T_{TRAP}) of trapped ions. The two ion entangling gates are made possible by the spin dependent phase term e^{±iηRe[α] imparted by the qubit state dependent kicks. The spin dependent phase term e}^{±iηRe[α] can be accumulated by the state dependent dynamics that result from the SDKs.}

In some embodiments, however, entangling gates implemented using SDKs (e.g., spin dependent kicks) alone face a number of problems. 1) For example, an SDK size η is relatively small, and thus many kicks or a large number of kicks are to be combined to achieve a gate. A kick rate (or an SDK rate) can be limited by a laser repetition rate, and thus placing a basic limit on a gate speed. 2) In an example, the fidelity of a single SDK must be unrealistically high in order for numerous SDKs to yield a single high fidelity gate. Spontaneous emission can place a limit on the highest achievable fidelity of a single SDK. 3) The SDK is its own inverse, for example, a second SDK after a first SDK inverts the action of the first SDK, making it difficult to combine the effects (e.g., to accumulate a spin dependent phase) of multiple SDKs (e.g., the first SDK and the second SDK). On the other hand, reversing a direction of an SDK while maintaining a fast gate operation may be non-trivial and may be challenging. 4) The SDKs are discretized, and thus setting the phase to create a maximally entangling gate may be challenging.

In general, a trapping potential of an ion trap can be manipulated. The manipulation of the trapping potential can include any suitable manipulation of a shape of the trapping potential which can generate any suitable equilibrium positions of respective ions in the ion trap. The trap frequency can also be changed. The trap frequency can be increased, and thus decreasing the trapping period. There can be arbitrarily many different equilibrium displacements. The manipulation of the trapping potential can include changing from one trapping potential to another trapping potential. The trapping potential manipulation can be achieved in any suitable duration Tₚ. The duration Tₚ can be larger or equal to the trapping period T_{TRAP}. The duration Tₚ of the trapping potential manipulation can be less than the trapping period T_{TRAP}. A manipulation of the trapping potential can be referred to as a fast manipulation of the trapping potential, for example, if the duration Tₚ is much less than the trapping period T_{TRAP}, such as Tₚ≤T_{TRAP}/K where K can be a pre-defined parameter such as 10 or 100. In an embodiment, a fast manipulation of the trapping potential causes a nearly instantaneously shift or displacement of a position of the trapped ion well, and thus sending the trapped ion into a large and well defined coherent motional state.

According to an embodiment of the disclosure, ultrafast gates can be implemented by a method that combines a manipulation (e.g., a fast manipulation) of the trapping potential with qubit state dependent kicks (e.g., spin dependent kicks). According to an exemplary aspect, an “ultrafast” gate can refer to a gate implemented within a gate duration T_{GATE} that is less than T_{TRAP} or comparable to T_{TRAP}. In an example, T_{GATE} of an ultrafast gate is less than BT_{TRAP} where the parameter β can be pre-defined, such as β is 1.5. The combination of the manipulation (e.g., the fast manipulation) of the trapping potential with the qubit state dependent kicks can resolve the problems described above, and make ultrafast gates feasible.

FIG. 5 shows an exemplary QIP system 500 according to an embodiment of this disclosure. The QIP system 500 can be a variation of the QIP system 200, and can include any or all components in the QIP system 200. Further, the QIP system 500 can be configured to combine and control a manipulation (e.g., a fast manipulation) of a trapping potential of an ion trap with qubit state dependent kicks (e.g., spin dependent kicks) to trapped ions such as trapped ions 531-532 in the ion trap. The QIP system 500 can include one or more trapped ions, such as an array of trapped ions including the trapped ions 531-532 (e.g., ¹⁷¹Yb⁺). The description of the trapped ion 410 can be applied to each of the trapped ions 531-532. Qubits associated with the trapped ions 531-532 can be entangled, for example, a qubit state of the trapped ion 531 can be dependent on a qubit state of the trapped ion 532.

The QIP system 500 can include the ion trap (e.g., the trap described in FIG. 1 or the trap 270 in FIG. 2), an optical system (e.g., partially located in the optical and trap controller 220 and/or in the chamber 250 in FIG. 2), and a controller (e.g., the optical and trap controller 220 in FIG. 2). The optical system can include laser systems 501-504. The controller can include a laser controller 521 configured to control operations of the laser systems 501-504 lasers and optical systems that provide optical beams that interact with the atoms or ions in the ion trap, a trap controller 522 configured to control operations of the ion trap, and a clock controller 523.

The ion trap can be formed using any suitable method. In an embodiment, the ion trap is an RF Paul trap formed by suitably arranging electrodes and by providing suitable voltages to control the electrodes. A trapping potential of the ion trap can be manipulated by manipulating an electrode configuration and/or by manipulating voltages applied to the electrodes. Multiple electrodes (e.g., electrodes A-L) can be arranged in a suitable configuration. In an example, the trap controller 522 is configured to control a trap DC controller 524 and an RF controller (also referred to as a resonant RF controller) 525. DC voltages can be applied to a subset of the multiple electrodes (e.g., the electrodes G-L) via the trap DC controller 524, and RF voltages can be applied to another subset of the multiple electrodes (e.g., the electrodes A-F) via the RF controller 525. Alternatively, the trap controller 522 is configured to control the DC voltages and the RF voltages at the electrodes A-L directly.

The optical system can be configured to provide suitable optical beams to perform qubit state dependent kicks (e.g., spin dependent kicks) to the trapped ions 531-532. The optical system (e.g., including the laser systems 501-504) can provide spatial and temporal control to the optical beams. In an embodiment, the laser systems 501-502 are configured to generate optical beams 511-512 that counter propagate and arrive at the trapped ion 531. The optical beams 511-512 can overlap (e.g., are synchronized) temporally. In an example, the optical beams 511-512 partially overlap in the time domain with a temporal displacement. The descriptions for the optical beams 421-422 can be applied to the optical beams 511-512. The optical beams 511-512 can cause a qubit state dependent kick (e.g., an spin dependent kick), for example, by driving a stimulated Raman transition between two qubit states |0> and |1> of the trapped ion 531, such as described in FIG. 4. Similarly, the laser systems 503-504 are configured to generate optical beams 513-514 that counter propagate and arrive at the trapped ion 532. The optical beams 513-514 can overlap (e.g., are synchronized) temporally. In an example, the optical beams 513-514 partially overlap in the time domain with a temporal displacement. The descriptions for the optical beams 421-422 can be applied to the optical beams 513-514. The optical beams 513-514 can cause a qubit state dependent kick (e.g., a spin dependent kick), for example, by driving a stimulated Raman transition between two qubit states |0> and |1> of the trapped ion 532, such as described in FIG. 4.

According to an embodiment of the disclosure, the controller (e.g., the trap controller 522) is configured to manipulate the trapping potential of the ion trap in a relatively short duration Tₚ, for example, the manipulation of the trapping potential is a fast manipulation of the trapping potential as described above. For example, the duration Tₚ is much less than the trapping period T_{TRAP}, such as Tₚ≤T_{TRAP}/K. In an embodiment, the fast manipulation of the trapping potential change (e.g., switch) a first trapping potential of the ion trap to a second trapping potential of the ion trap. Referring to FIG. 5, the first trapping potential can have a first equilibrium position c10 for the trapped ion 531 and a first equilibrium position c20 for the trapped ion 532, and the second trapping potential can have a second equilibrium position c11 for the trapped ion 531 and a second equilibrium position c21 for the trapped ion 532. In an example, the first equilibrium positions c10 and c20 are located at local minima of the first trapping potential, and the second equilibrium positions c11-c21 re located at local minima of the second trapping potential.

In an example, the switching from the first trapping potential to the second trapping potential can cause a nearly instantaneously (e.g., with the duration Tₚ) shift or displacement of equilibrium positions of the trapping potential, and thus a shift of the equilibrium positions of the trapping potential from the first equilibrium position c10 and c20 of the trapped ions 531-532 to the second equilibrium positions c11 and c21, respectively. The trapped ion 531 and/or the trapped ion 532 can be sent into large coherent motional state(s) |α> with the displacements of the respective equilibrium positions of the trapping potential.

Any suitable switching method can be applied to control electrode(s) in the electrodes A-L to implement the manipulation (e.g., the fast manipulation) of the trapping potential of the ion trap. In an example, voltages applied to a subset of the electrodes (e.g., including B, H, D, and J) are manipulated (e.g., switched) within the duration Tₚ (e.g., 1-10 ns), for example, to switch the trapping potential (e.g., from one trapping potential to another trapping potential).

According to an embodiment of the disclosure, the laser systems 501-502 can be configured to implement a qubit state dependent kick (e.g., a spin dependent kick) to the trapped ion 531 when the trapped ion 531 is associated with the first trapping potential or the second trapping potential. The laser systems 503-504 can be configured to implement a qubit state dependent kick (e.g., a spin dependent kick) to the trapped ion 532 when the trapped ion 532 is associated with the first trapping potential or the second trapping potential. In an example, the optical beams 511-512 arrive at the trapped ion 531 (e.g., located at c10), for example, the optical beams 511-512 are focused onto an area that is centered around c10. The laser systems 503-504 can be configured to generate optical beams 513-514 that arrive at the trapped ion 532 (e.g., located at c20), for example, the optical beams 513-514 are focused onto an area that is centered around c20. The laser systems 501-504 can be configured to control directions of the optical beams 511-514 and/or positions of the optical beams 511-514. In an example, the optical beams 511-514 can track the positions of the trapped ions 531-532, respectively.

The laser systems 501-504 can be implemented using any suitable components. The laser systems 501-504 can be configured to generate one or more pulse pairs, such as a train of pulse pairs. Each of the pulse pairs can include two counterpropagating optical pulses such as described with reference the optical beams 421-422, 511-512, and/or 513-514.

The laser systems 503-504 can have components that are different from the laser systems 501-502, for example, the laser systems 501-502 are separate from the laser systems 503-504 such as shown in FIG. 5.

In an embodiment, the laser systems 501-502 is implemented using a single laser system (or a single optical system) including a single laser (e.g., a mode-locked 355 nm laser), Mach-Zehnder interferometer(s), a pulse picker, acoustic optical modulators (AOMs), and/or the like. Two output beams from the respective AOMs can be the optical beams 511-512. Similarly, the laser systems 503-504 can be implemented using a mode-locked laser, a pulse picker, stacked Mach-Zehnder interferometers, and two AOMs. Two output beams from the respective AOMs can be the optical beams 513-514. Alternatively, the optical beams 511-512 from the laser systems 501-502 can be manipulated to generate the optical beams 513-514 by controlling components in the laser systems 511-512. In an example, a single laser system (or a single optical system) is used to generate the optical beams 511-514.

Functions of the controller can be implemented using any suitable hardware, software, and the like. The laser controller 521, the trap controller 522, and/or the clock controller 523 can be separate controllers or can be integrated into a single controller (e.g., the optical and trap controller 220 described in FIG. 2).

In an example, the controller described with reference to FIG. 5 can be configured to further perform functions of the optical and trap controller 220 described in FIG. 2. Alternatively, the QIP system 500 can further includes an optical and trap controller that is similar or identical to the optical and trap controller 220 described in FIG. 2.

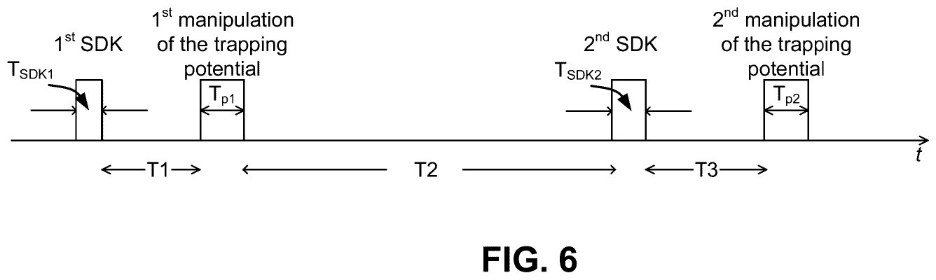

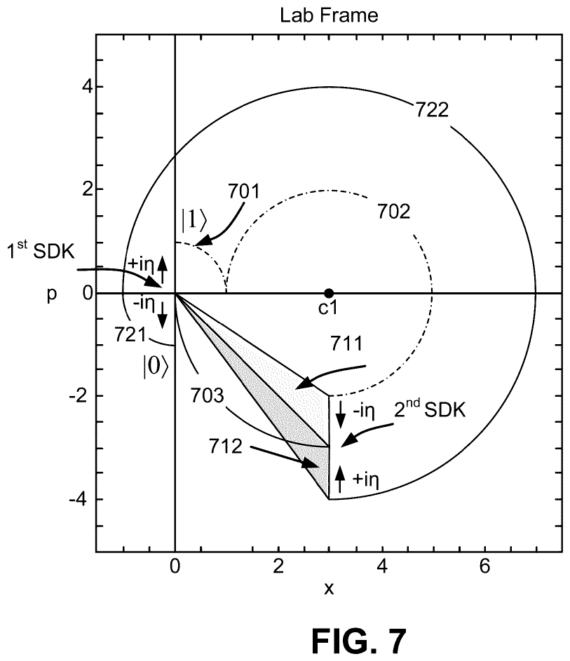

FIG. 6 shows an exemplary sequence of SDKs (e.g., spin dependent kicks) and manipulations of the trapping potential according to an embodiment of the disclosure. The horizontal axis indicates time t. SDKs can be implemented by optical beams, and the sequence of SDKs and the manipulations of the trapping potential can indicate a sequence of the optical beams (or the optical pulses) and the manipulations of the trapping potential. The optical beams 511-512 and the trapped ion 531 are used as an example in the descriptions of FIGS. 6-7. The description for FIGS. 6-7 can be suitably adapted for the optical beams 513-514 and the trapped ion 532. In an embodiment, the trapped ions 531-532 are in the same ion trap, and thus the same trapping potential is used to trap the trapped ions 531-532. The equilibrium positions of the trapped ions 531-532 can be different, as described in FIG. 5.

According to an embodiment of the disclosure, the controller can be configured to control operations of the optical system (e.g., the laser systems 501-504) and the ion trap. Referring to FIG. 6, the controller (e.g., via the laser controller 521) can be configured to cause the optical system to perform a first SDK (e.g., a first spin dependent kick) (or a 1^{st} SDK) to the trapped ion 531 that is in a first spin state (e.g., |0>) and a first motional state (e.g., |α>) prior to the first SDK. The first SDK can include a first momentum kick to the trapped ion. The first momentum kick (e.g., a direction or a sign of the first momentum kick) can depend on the first spin state and can be associated with a spin flip from the first spin state into a second spin state (e.g., |1>). In an example, during the 1^{st} SDK, a pulse (such as a microwave pulse) is applied to the trapped ion 531 and resonantly drives the trapped ion 531 from the first spin state to the second spin state.

Referring to FIG. 6, the controller (e.g., via the trap controller 522) can be configured to cause a first trapping potential of the ion trap being switched to a second trapping potential of the ion trap (referred to as a 1^{st} manipulation of the trapping potential). The first SDK can be performed on the trapped ion 531 associated with the first trapping potential, for example, using the optical beams 511-512 that arrive at c10.

In an example, a current spin state is a spin state of the trapped ion 531 after the first SDK and the 1^{st} manipulation of the trapping potential (e.g., switching the first trapping potential of the ion trap to the second trapping potential) are performed. According to an embodiment of the disclosure, a phase associated with the current spin state of the trapped ion 531 can depend on a size (or a magnitude) η of the first momentum kick and the 1^{st} manipulation of the trapping potential (e.g., including a displacement Δd between the first equilibrium position c10 and the second equilibrium position c11, e.g., Δd=c11−c10 or Δd=c11 if c10 is 0). If the first equilibrium position c10 is set to 0, the displacement is c11 and the phase associated with the current spin state of the trapped ion 531 can be η×c11, which is amplified by a factor of the displacement Δd (e.g., c11). The current spin state can be one of the first spin state and the second spin state, such as |0> or |1>. In an example, the current spin state is the first spin state.

The controller can be configured to control timings of qubit state dependent kicks (e.g., spin dependent kicks) and manipulations (e.g., fast manipulations) of the trapping potentials, for example, via the clock controller 523 in FIG. 5. The controller (e.g., via the clock controller 523) can be configured to synchronize the qubit state dependent kicks and the manipulations (e.g., the fast manipulations) of the trapping potentials, for example, by synchronizing the operations of the laser controller 521 and the trap controller 522. In an embodiment, the controller is configured to control respective arrival times of the optical beams 511-512 at the trapped ion 531 and respective switching times of voltages applied to the electrodes A-L.

Referring to FIG. 6, the first SDK can occur prior to the switching of the first trapping potential. In an embodiment, the controller (e.g., via the clock controller 523) is configured to cause a first delay T1 between the first SDK and the 1^{st} manipulation of the trapping potential.

Referring to FIG. 6, in an embodiment, after switching the first trapping potential to the second trapping potential, the controller is configured to cause the optical system to perform a second SDK (e.g., a second spin dependent kick) (or a 2^{nd} SDK) on the trapped ion 531. The second SDK can include a second momentum kick to the trapped ion 531 that is opposite to the first momentum kick and is associated with a spin flip from the second spin state into the first spin state. The controller (e.g., via the clock controller 523) is configured to cause a second delay T2 between the second SDK and the switching of the first trapping potential to the second trapping potential. The second SDK can be performed on the trapped ion 531 associated with the second trapping potential, for example, using the optical beams 511-512 that arrive at c11.

Referring to FIG. 6, in an embodiment, the controller is configured to cause the second trapping potential of the ion trap being switched to the first trapping potential of the ion trap (referred to as a 2^{nd} manipulation of the trapping potential). The controller (e.g., via the clock controller 523) is configured to cause a third delay T3 between the second SDK and the changing of the second trapping potential (the 2^{nd} manipulation of the trapping potential).

In an example, the current spin state of the trapped ion 531 after the 2^{nd} manipulation of the trapping potential is the first spin state. After the 2^{nd} manipulation of the trapping potential, the phase associated with the current spin state can depend on the size of the first momentum kick η and the displacement Δd between the first equilibrium position c10 and the second equilibrium position c11.

As described above, the first SDK and the second SDK can be performed on the trapped ion 531 that are at different equilibrium positions, and thus the optical beams 511-512 can be displaced, for example, by the displacement Ad. The controller is configured to provide the spatial control of the optical beams 511-512. The controller is also configured to provide the temporal control of the optical beams 511-512 including synchronization (e.g., by controlling the delays T1, T2, and T3) of the optical beams 511-512 with respect to the 1^{st} manipulation of the trapping potential and the 2^{nd} manipulation of the trapping potential. The controller is also configured to provide the temporal control between the optical beams 511-512.

A duration T_{SDK1} of the first SDK and a duration T_{SDK2} of the second SDK can be less (e.g., much less) than the trap period T_{TRAP} of the trapped ion 531. In an example, a duration Tₚ₁ where the first trapping potential is switched to the second trapping potential and a duration Tₚ₂ where the second trapping potential is switched to the first trapping potential can be less than the trap period T_{TRAP} of the trapped ion 531. For example, T_{SDK1}≤T_{TRAP}/M, T_{SDK2}≤T_{TRAP}/M, Tₚ₁≤T_{TRAP}/K and Tₚ₂≤T_{TRAP}/K where M and K are the pre-defined parameters described above. T_{SDK1} can be identical to or different from T_{SDK2}. Tₚ₁ can be identical to or different from Tₚ₂.

Referring to FIG. 6, in an example, T1 is Tₜᵣₐₚ/4, T2 is 3Tₜᵣₐₚ/4, and T3 is Tₜᵣₐₚ/4. FIG. 7 shows an exemplary phase-space trajectory or a phase space path of the trapped ion 531 corresponding to the sequence shown in FIG. 6 and T1 is Tₜᵣₐₚ/4, T2 is 3Tₜᵣₐₚ/4, and T3 is Tₜᵣₐₚ/4. The entanglement can be a difference in the phase space enclosed by all the modes (e.g., one mode in this case) between the different ion basis states such as (|00>, |01>, |10>, |11>). In an embodiment, |00> and |11> accumulate the same phase and |01> and |10> accumulate the same phase. Each mode and the state dependent kick can be viewed in the same picture as described in the disclosure.

FIG. 6 is described using one trapped ion as an example. Optical beams such as 511-514 can interact with multiple trapped ions in the trapping potential. In an example, during the 1^{st} SDK to the trapped ion 531, the optical beams 511-514 overlap at least partially in the time domain and drive two stimulated Raman transitions such that spin states of the qubits associated with the trapped ions 531-532 are driven from |00> to an entangled state. An example of an entangled state is ½ (|00>+i|01>+i|10>+|11>) that is generated from ½ (|00>+|01>+|10>+|11>). For example, a 1^{st} SDK is applied to the trapped ion 532 in the ion trap having the first trapping potential. The trapped ion 532 is in a first spin state and a first motional state prior to the 1^{st} SDK to the trapped ion 532. The 1^{st} SDK to the trapped ion 532 includes a first momentum kick to the trapped ion 532 that depends on the first spin state of the trapped ion 532 and is associated with a spin flip from the first spin state of the trapped ion 532 into a second spin state of the second trapped ion 532. During the 2^{nd} SDK, the optical beams 511-514 overlap at least partially in the time domain and drive two stimulated Raman transitions such that spin states of the qubits associated with the trapped ions 531-532 are driven from the entangled state to another state (e.g., a non-entangled state), such as from ½ (|00>+i|01>+i|10>+|11>) to ½ (|00>+|01>+|10>+|11>). Any suitable number of optical beams in any suitable configuration can be used to achieve the 1^{st} SDK and the 2^{nd} SDK for the trapped ions 531-532. For example, the optical beams 511 and 513 are the same optical beam that is directed to multiple trapped ions such as the trapped ions 531-532, and the three optical beams 511, 512, and 514 can be used to achieve the 1^{st} SDK and the 2^{nd} SDK for the trapped ions 531-532.

In the example shown in FIG. 7, the trapped ion 531 has a single motional mode of period T (e.g., T_{TRAP}=T) and an associated frequency ω=2π/T. An initial general state of the trapped ion 531 includes the first spin state being |0> or |1> and a coherent motional state |α> being in the motional ground state |α=0>. The trapped ion 531 can be subjected to the sequence shown in FIG. 6 including: 1) the 1^{st} SDK of a size η; 2) waiting for a time T/4 (the first delay T1 or the first evolution); 3) the 1 ^{st} manipulation of the trapping potential (e.g., a fast displacement of the equilibrium position from the first equilibrium position c10 to the second equilibrium position (or the new equilibrium position) c11); 4) waiting for a time 3T/4 (the second delay T2 or the second evolution); 5) the 2^{nd} SDK of a size−η (“−” sign indicating an opposite direction from the first SDK); 6) waiting for a time T/4 (the third delay T3 or the third evolution); and 7) the 2^{nd} manipulation of the trapping potential (e.g., a fast displacement of the equilibrium position from c11 to the original equilibrium position c10).

During 2), 4), and 6) in the sequence, ions such as the trapped ion 531 can undergo free evolutions about respective equilibrium positions c (e.g., c10 or c11 for the trapped ion 531; c20 or c21 for the trapped ion 532). In the example shown in FIG. 7, c10=0. A free evolution for a time t about the equilibrium position c (e.g., an arbitrary equilibrium position c) can be described by Eq. (3).

$$\vert α > \to \vert ( α - c ) {e}^{- i ω t} + c > \qquad Eq . ( 3 )$$

The impact of the sequence described above on the trapped ion 531 that starts in the initial general state (including the first spin state (e.g., |0>) and the motional ground state |α=0>) can be determined using Eqs. (1)-(3). At a given moment, the state of the trapped ion 531 can be given by Eq. (4).

$$\vert ψ > \to {e}^{i {φ}_{0}} \vert 0 > \vert {α}_{0} > + {e}^{i {φ}_{1}} \vert 1 > \vert {α}_{1} > \qquad Eq . ( 4 )$$

where e^{iφ}^{ᵢ}|i>|α> can correspond to a spin state i with a motional state αᵢ and a phase φᵢ.

In the example shown in FIG. 7, a single mode of period T is considered and α is considered in the original lab frame. The 1^{st} SDK is applied to the trapped ion 531 in the initial general state. If the first spin state is |0>, |0> is flipped to |1> after the 1^{st} SDK and the first momentum kick is indicated by +iη and an upward arrow. The parameter η can represent (e.g., can be) a size of the first momentum kick or the 1^{st} SDK. The first evolution (indicated by a dashed line 701) around c10 (e.g., c10=0 in the example of FIG. 7) for the duration T1 (e.g., T/4) follows the 1^{st} SDK. Subsequently, the 1^{st} manipulation of the trapping potential occurs and displaces the equilibrium position from c10 to c11. The second evolution (indicated by a dashed line 702) around c11 for the duration T2 (e.g., 3T/4) follows the 1^{st} manipulation of the trapping potential. The 2^{nd} SDK is applied to the trapped ion 531 following the second evolution. |1> is flipped back to |0> after the 2^{nd} SDK and the second momentum kick is indicated by −iη and a downward arrow. Subsequently, the third evolution (indicated by a solid line 703) around c11 for the duration T3 (e.g., T/4) follows the 2^{nd} SDK. The 2^{nd} manipulation of the trapping potential occurs after the third evolution and displaces the equilibrium position from c11 back to c10. Thus, the current general state of the trapped ion 531 after the 2^{nd} manipulation of the trapping potential can include a current spin state |0> (i.e., the “zero” spin state) and a current motional state (e.g., the motional ground state |α=0>) with the phase do being η×c1. For example, the current general state of the trapped ion 531 is represented as e^{iη×c1}|0>|α=0>.

If the first spin state (e.g., the spin state of the trapped ion 531 prior to the 1 ^{st} SDK) is |1>, the above description can be suitably adapted. For example, the first evolution and the second evolution are indicated by solid lines 721-722. The third evolution is also indicated by the solid line 703.

Referring to FIG. 7, shaded areas 711-712 show the relevant phase space areas. Each triangle (e.g., 711 or 712) has an area (e.g., a phase space area)±(ηλc1)/2, corresponding to each spin state acquiring a phase of ±η×c1.

The above descriptions are summarized in Table 1 below.

TABLE 1
Sequence of motional states associated with SDKs (e.g.,
spin dependent kicks) and fast displacements

| Step | αᵢᵢ | φᵢᵢ |
|---|---|---|
| Initial state | 0 | 0 |
| 1) 1^{st} SDK (size η) | ±iη | 0 |
| 2) Free evolution time T/4 | ±η | 0 |
| 3) 1^{st} fast displacement by c11 | ±η | 0 |
| 4) Free evolution time 3T/4 | i(±η − c11) + c11 | 0 |
| 5) 2^{nd} SDK (size − η) | −ic11 + c11 | ±ηc11 |
| 6) Free evolution T/4 | 0 | ±ηc11 |
| 7) 1^{st} fast displacement by − c11 | 0 | ±ηc11 |

In Table 1, αᵢᵢ and φᵢⱼ represent the motional state and the phase in a step ii (ii being 1, 2, 3, 4, 5, 6, or 7). As described above, the two spin states can acquire different phases. In the example shown in FIG. 7 and Table 1, |0> (i.e., the “zero” spin state) acquires a phase of +ηc11 and |1> (i.e., the “one” spin state) acquires a phase of −ηc1. The phase acquired (e.g., +ηc11 or −ηc11) can be tunable (e.g., continuously tunable) by a size of the displacement Δd. Δd is c11 when c10 is 0. As described above, the manipulation of the trapping potential can include decreasing the trapping period, and thus the delays (also referred to as waiting periods) (e.g., T1-T3 in FIGS. 6-7 and Table 1) can be decreased, which can increase a gate speed. The shape and the trapping frequency can be manipulated independently or together.

The above description is for the trapped ion 531 starting in the motional ground state |α=0> for purposes of brevity. The description above (e.g., Table 1) is done for the motional ground state |α=0> because of simplification. The result holds true if the trapped ion 531 starts in other motional states |α>. The manipulation(s) of the trapping potential (e.g., the fast displacement(s) between c10 and c11) can effectively amplify an impact (e.g., a size) of the SDKs on the state of the trapped ion 531, for example, allowing a large spin-dependent phase to be imparted. The SDK size (e.g., η) can be amplified by a factor that is the displacement Δd (e.g., Δd=c11−c10). The displacement becomes c11 when c10 is chosen to be 0. Optionally, the above sequence (e.g., including steps 1-7) can be repeated to increase the phase associated with |0> or |1>, and thus achieving a gate. In an example, the phase associated with |0> or |1> after repeating the above sequence J times is proportional to J×η×c11.

As described above, entangling gates implemented using SDKs alone face a number of problems. The combination of the SDKs and the manipulations (e.g., the fast manipulations) of the trapping potential (e.g., the fast displacements) can overcome the problems and thus achieve relatively fast gates such as ultrafast gates that operate within the gate duration T_{GATE} that is less than T_{TRAP} or comparable to T_{TRAP}. For example, a phase (e.g., η×Δd) acquired after a single sequence (e.g., as shown in FIG. 6) of SDKs and the manipulations of the trapping potential is larger than a phase (e.g., η) obtained by SDKs alone. Thus, by including manipulations of the trapping potential, a smaller (e.g., much smaller) number of SDKs can be used to acquire a certain amount of phase and thus to achieve a gate faster than using SDKs alone. Further, referring to FIGS. 6-7 and Table 1, although a sign of the 2^{nd} SDK (−iη) is opposite to that of the 1^{st} SDK, the 2^{nd} SDK does not invert the action of the 1 ^{st} SDK with respect to a phase accumulation with a suitable manipulation of the trapping potential. Thus, the phase accumulates and is amplified with the 2^{nd} SDK. Further, though the SDKs are discrete, the phase accumulated (e.g., η×Δd) can be continuously tunable by varying a size of the displacement Δd, for example, by controlling voltages at the electrodes to vary equilibrium positions to set the phase to create a maximally entangling gate. In addition, the fidelity of the gate can increase with the manipulation of the trapping potential.

By combining the SDKs and the manipulations (e.g., the fast manipulations) of the trapping potential (e.g., the fast displacements), a gate on a two-qubit chain can be created as described below. For example, a two-qubit gate between pairs of ions is achieved by using mechanical effects to couple the motion (e.g., a motional state |α>) and internal states (e.g., qubit states) of trapped ions. Accordingly, a speed of the quantum gate can be relatively fast as described above.

The sequence used in FIG. 7 and Table 1 is a relatively simple sequence that demonstrates the advantages in combining displacements (e.g., fast displacements) with SDKs. Any suitable sequence that includes one or more SDK(s) to one or more ions and one or more manipulations of the trapping potential (e.g., one or more displacements) can be applied to achieve a large phase, and thus a fast gate. A sequence can be modified (e.g., optimized) based on specific requirements for the sequence, such as a high fidelity of a gate, a high speed of the gate, and/or the like. A sequence can include a subset of the steps 1-7 described above. A sequence can include more steps than the steps 1-7 described above. One or more steps in the steps 1-7 can be modified. Any suitable order can be applied to the steps in the sequence.

According to an embodiment of the disclosure, the controller can be configured to perform the 1^{st} SDK as follows. The controller can be configured to apply one or more first pairs of optical pulses to the trapped ion 531. Each pair of optical pulses can include two counterpropagating pulses (e.g., the optical beams 511-512) arriving at the trapped ion 531. The two counterpropagating pulses can completely or partially overlap in the time domain. Spectral components of the two counterpropagating pulses can be separated by an energy difference based on energy levels of the first spin state and the second spin state, for example, to drive a Stimulated Raman transition. For example, the energy difference can be the energy difference between |0> and |1> indicated by the frequency f as described above.

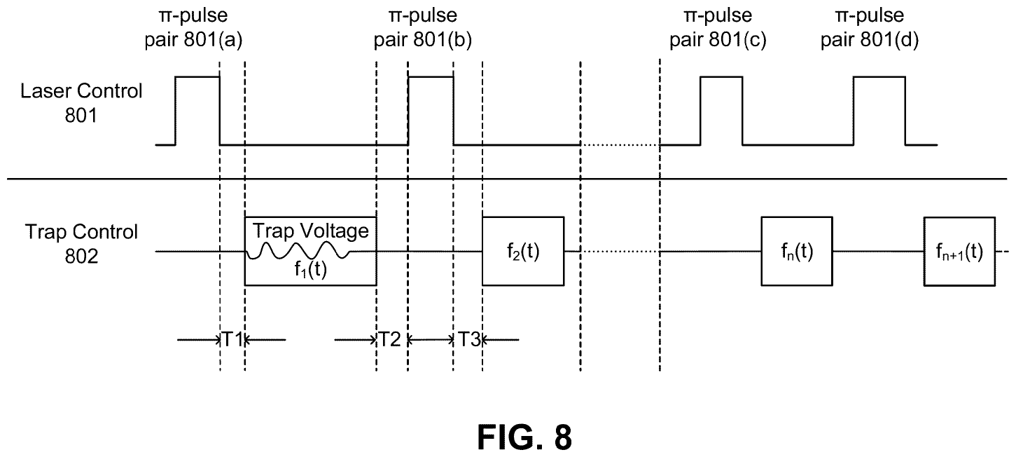

FIG. 8 shows an exemplary optical pulses and ion trap control timing schematics according to an embodiment of the disclosure. The top row shows a laser control 801 including timing of optical pulse pairs used to perform SDKs. In the example of FIG. 8, a single pair of optical pulses is used to perform an SDK, and a respective pulse area of each optical pulse in the pair of optical pulses is π. For example, the pulse pair 801(a) (e.g., the optical beams 511-512) is used to perform the first SDK, and the pulse pair 801(b) is used to perform the second SDK. In an example, each π pulse includes pulses with the same wavevector adding to a π pulse area. In an example, larger SDKs can be generated by including multiples of π pulse areas where wavevectors are reversed for each a pulse area.

The bottom row shows a trap control 802 including timing of trap voltage(s) used to perform manipulations of the trapping potential. In the example of FIG. 8, trap voltage(s) indicated by f₁(t) can be applied to one or more electrodes in the ion trap to change the trapping potential and perform the first manipulation of the trapping potential. The specific voltage profile shown in FIG. 8 is for purposes of illustration. Any suitable voltage profile can be selected, for example, based on specific requirements. Trap voltage(s) indicated by f₂(t) can be applied to one or more electrodes in the ion trap to change the trapping potential and perform the second manipulation of the trapping potential. FIG. 8 shows the first delay T1, the second delay T2, and the third delay T3 as described above. In an example, after the second manipulation of the trapping potential, the trapped ion 531 acquires a phase that is proportional to the SDK size (or the SDK magnitude) η and the displacement between c11 and c10 as described with reference to FIGS. 6-7.

It should be appreciated that the above sequence can be repeated any suitable number of times. In an embodiment, the trapped ion acquires an additional phase each time the above sequence is repeated. For example, pulse pairs 801(c)-801(d) can be used to perform the first SDK and the second SDK, respectively, and trapping voltage(s) indicated by fₙ(t) and fₙ₊₁(t) can be applied to one or more electrodes in the ion trap to change the trapping potential and perform the first and second manipulations of the trapping potential, respectively.

Referring to FIG. 8, in an example, the one or more first pairs of optical pulses to achieve the first SDK include only one pair of optical pulses (e.g., the pulse pair 801(a)). In an example, a respective pulse area of each optical pulse is π.

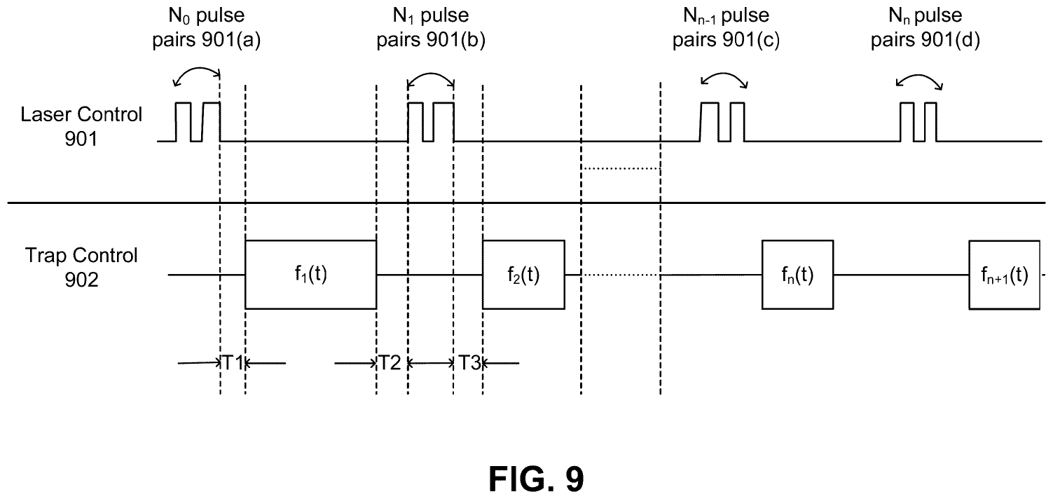

FIG. 9 shows an exemplary optical pulses and ion trap control timing schematics according to an embodiment of the disclosure. The top row shows a laser control 901 including timing of optical pulse pairs used to perform SDKs. In the example of FIG. 9, multiple pairs of optical pulses are used to perform an SDK. For example, N₀ pulse pairs 901(a) are used to perform the first SDK, and N₁ pulse pairs 901(b) are used to perform the second SDK. N₀ and N₁ are larger than 1.

The bottom row shows a trap control 902 including timing of trap voltage(s) used to perform manipulations (e.g., fast manipulations) of the trapping potential. In the example of FIG. 9, trap voltage(s) indicated by f₁(t) can be applied to one or more electrodes in the ion trap to change the trapping potential and perform the first manipulation of the trapping potential. Trap voltage(s) indicated by f₂(t) can be applied to one or more electrodes in the ion trap to change the trapping potential and perform the second manipulation of the trapping potential. FIG. 9 shows the first delay T1, the second delay T2, and the third delay T3 as described above. In an example, after the second manipulation of the trapping potential, the trapped ion acquires a phase that is proportional to the SDK size η and the displacement between c1 and c0.

The above sequence in FIG. 9 can be repeated any suitable number of times. In an embodiment, the trapped ion acquires an additional phase each time the above sequence is repeated. For example, Nₙ₋₁ pulse pairs 901(c) and Nₙ pulse pairs 901(d) can be used to perform the first SDK and the second SDK, respectively, and trapping voltage(s) indicated by fₙ(t) and fₙ₊₁(t) can be applied to one or more electrodes in the ion trap to change the trapping potential and perform the first and second manipulations of the trapping potential, respectively.

Referring to FIG. 9, the one or more first pairs of optical pulses include the N₀ pairs of optical pulses 901(a). In an example, a respective pulse area of each optical pulse is π. In an example, a total pulse area of N₀ optical pulses in the respective N₀ pairs of optical pulses 901(a) is π. In an example, a respective pulse area of each optical pulse is π/N₀. In another example, the N₀ optical pulses can have different pulse areas. The description regarding each pulse area can be applied to the N₁ pulse pairs 901(b), the Nₙ₋₁ pulse pairs 901(c) and the Nₙ pulse pairs 901(d). For example, a respective pulse area of each optical pulse in the N₁ pulse pairs 901(b) is π or π/N₁.

In the example of FIG. 9, two pulse pairs are shown for the pulse pairs 901(a)-901(d). N₁-Nₙ can be any number that is larger than 1.

In an embodiment, the equilibrium positions of the respective ions in the ion trap can be manipulated (or displaced) through any suitable (e.g., arbitrary) time-dependent trapping potential c(t), while any suitable (e.g., an arbitrary) sequence of discrete SDKs can be applied in a sequence. Accordingly, optimum gate sequences can be found that entangle two arbitrary ions within a long ion chain, while closing phase space on normal modes (e.g., all normal modes), such as done with modulated Molmer-Sorensen gates.

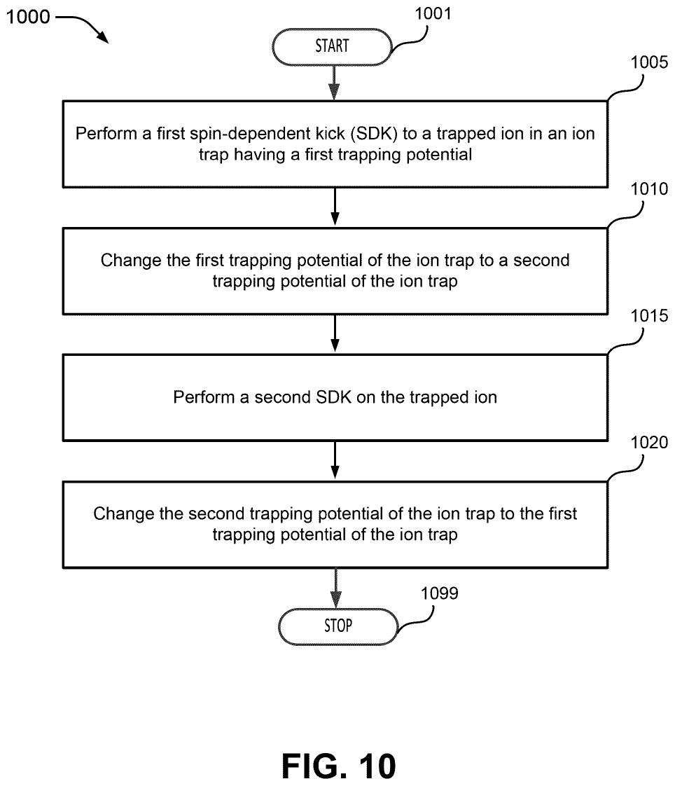

FIG. 10 illustrates a method 1000 for combining qubit state dependent kick(s) (e.g., spin dependent kick(s)) and manipulations (e.g., fast manipulation(s)) of a trapping potential of a trapped ion according to an embodiment of the present disclosure. The method 1500 can be used to acquire a relatively large phase with fewer SDKs (within a shorter duration), and thus achieving a gate with relatively high speed. The method 1500 may be performed by one or more of the QIP system 200 or 500, the computer device 300, and/or one or more subcomponents thereof.

The method 1500 can start at 1001. A trapped ion (e.g., the trapped ion 531) in an ion trap can be in a first trapping potential. The trapped ion can be in a first spin state (e.g., |0>) and a first motional state (or a first coherent motional state |α>).

At 1005, a first qubit state dependent kick (e.g., a first SDK) can be performed to the trapped ion in the first trapping potential. The first SDK can include a first momentum kick to the trapped ion. The first momentum kick can depend on the first spin state and can be associated with a spin flip from the first spin state into a second spin state. A duration of the first SDK can be less than a trap period T_{TRAP} of the trapped ion.

In an embodiment, the first SDK is performed by applying one or more first pairs of optical pulses to the trapped ion. Each pair of optical pulses can include two counterpropagating pulses arriving at the trapped ion. Spectral components of the two counterpropagating pulses can be separated by a frequency difference based on energy levels of the first spin state and the second spin state.

In an example, the one or more first pairs of optical pulses include only one pair of optical pulses, such as described in FIG. 8. In an example, a respective pulse area of each optical pulse is π.

In an example, the one or more first pairs of optical pulses include N₀ pairs of optical pulses, such as described in FIG. 9. For example, a respective pulse area of each optical pulse is π, such as described in FIG. 9. In another example, a total pulse area of N₀ optical pulses in the respective N₀ pairs of optical pulses is π. For example, a respective pulse area of each optical pulse is π/N₀, such as described in FIG. 9.

In an example, the trapped ion is a ¹⁷¹Yb⁺ ion, the first spin state and the second spin state correspond to two hyperfine levels |0> and |1> of a ²S_{1/2} ground manifold of the ¹⁷¹Yb⁺ ion, and each pair of optical pulses drives a stimulated Raman transition between the two hyperfine levels |0> and |1>.

At 1010, the first trapping potential of the ion trap can be changed to a second trapping potential of the ion trap. A first center position c0 of the first trapping potential of the ion trap can be changed (or displaced) to a second center position c1 of the second trapping potential of the ion trap. A duration of changing the first trapping potential to the second trapping potential can be less than the trap period T_{TRAP}.

In an example, the first trapping potential is changed by manipulating voltages at electrodes of the ion trap, such as described above with respect to FIGS. 5-6.

In an example, a first delay T1 is between the first SDK and the changing of the first trapping potential, and the first SDK occurs prior to the changing of the first trapping potential.

At 1015, after changing the first trapping potential to the second trapping potential, a second SDK can be performed on the trapped ion. The second SDK can include a second momentum kick to the trapped ion. The second momentum kick can be opposite to the first momentum kick and can be associated with a spin flip from the second spin state into the first spin state. The second momentum kick can have a same amplitude as that of the first momentum kick. The second momentum kick can have a direction (e.g., a sign) that is opposite to that of the first momentum kick. A duration of the second SDK can be less than the trap period T_{TRAP}, and a second delay T2 is between the changing of the first trapping potential and the second SDK.

At 1020, the second trapping potential of the ion trap can be changed back to the first trapping potential of the ion trap. A duration of changing the second trapping potential to the first trapping potential can be less than the trap period T_{TRAP}.

In an example, a third delay T3 is between the second SDK and the changing of the second trapping potential.

In an example, T1 is T_{TRAP}/4, T2 is 3T_{TRAP}/4, and T3 is T_{TRAP}/4.

In an example, a phase associated with a current spin state of the trapped ion depends on a size of the first momentum kick and a displacement between the first center position c0 and the second center position c1. The current spin state can be obtained after the 2^{nd} manipulation of the trapping potential. The current spin state can be one of the first spin state and the second spin state.

The method 1000 proceeds to 1099, and terminates.

The method 1000 can be suitably adapted. Step(s) in the method 1000 can be modified and/or omitted. Additional step(s) can be added. Any suitable order of implementation can be used.

Embodiments in the disclosure may be used separately or combined in any order.

Aspects of the present disclosure include a method for quantum information processing (QIP) can include performing a first state dependent kick (SDK) (e.g., a first spin-dependent kick) to a trapped ion in an ion trap having a first trapping potential. The trapped ion can be in a first spin state and a first motional state prior to the first SDK. The first SDK can include a first momentum kick to the trapped ion that depends on the first spin state and is associated with a spin flip from the first spin state into a second spin state. A duration of the first SDK can be less than a trap period Ttrap of the trapped ion. The method for QIP can include changing a first equilibrium position c10 of the first trapping potential of the ion trap to a second equilibrium position c11 of a second trapping potential of the ion trap. A duration of changing the first trapping potential to the second trapping potential is less than the trap period Ttrap. A phase associated with a current spin state of the trapped ion is amplified by a displacement between the first equilibrium position c10 and the second equilibrium position c11, the phase is dependent on a size of the first momentum kick and the displacement, and the current spin state is one of the first spin state and the second spin state.

Aspects of the present disclosure includes systems and methods for QIP. The system can include an array of trapped ions including a trapped ion, an optical system configured to generate pairs of optical pulses, an ion trap, and a controller. The ion trap is configured to trap the trapped ion. A trapping potential of the ion trap can be switchable between a first trapping potential and a second trapping potential. The first trapping potential has a first equilibrium position c10, and the second trapping potential has a second equilibrium position c11.

The controller is configured to control operations of the optical system and the ion trap. The controller can cause the optical system to perform a first state dependent kick (SDK) (e.g., a first spin-dependent kick) to the trapped ion that is in a first spin state and a first motional state prior to the first SDK. The first SDK includes a first momentum kick to the trapped ion that depends on the first spin state and is associated with a spin flip from the first spin state into a second spin state. A duration of the first SDK is less than a trap period Tₜᵣₐₚ of the trapped ion. The controller can switch the first trapping potential of the ion trap to the second trapping potential of the ion trap. In an example, a duration of switching the first trapping potential to the second trapping potential is less than the trap period Tₜᵣₐₚ. A phase associated with a current spin state of the trapped ion is amplified by a displacement between the first equilibrium position c10 and the second equilibrium position c11, the phase is dependent on a size of the first momentum kick and the displacement, and the current spin state is one of the first spin state and the second spin state.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for quantum information processing, the method comprising:
performing a first state dependent kick (SDK) to a first trapped ion in an ion trap having a first trapping potential, the first trapped ion being in a first spin state and a first motional state prior to the first SDK, the first SDK including a first momentum kick to the first trapped ion that depends on the first spin state and is associated with a spin flip from the first spin state into a second spin state, a duration of the first SDK being less than a trap period Tₜᵣₐₚ of the first trapped ion; and
changing a first trapping potential of the ion trap to a second trapping potential of the ion trap to amplify a phase associated with a current spin state of the first trapped ion.

2. The method of claim 1, wherein
the changing the first trapping potential comprises changing a first equilibrium position c10 of the first trapped ion in the first trapping potential to a second equilibrium position c11 of the first trapped ion in the second trapping potential;
the phase associated with the current spin state of the first trapped ion is amplified by a displacement between the first equilibrium position c10 and the second equilibrium position c11.

3. The method of claim 1, further comprising providing a first delay T1 between the first SDK and the changing of the first trapping potential, the first SDK being performed prior to the changing of the first trapping potential.

4. The method of claim 3, further comprising:
after changing the first trapping potential to the second trapping potential, performing a second SDK on the first trapped ion, the second SDK including a second momentum kick to the first trapped ion that is opposite to the first momentum kick and is associated with a spin flip from the second spin state into the first spin state,
wherein a duration of the second SDK is less than the trap period Tₜᵣₐₚ, a second delay T2 is between the second SDK and the changing of the first trapping potential.

5. The method of claim 4, further comprising:
changing the second trapping potential of the ion trap to the first trapping potential of the ion trap,
wherein a third delay T3 is between the second SDK and the changing of the second trapping potential.

6. The method of claim 4, wherein at least one of (i) a duration of changing the first trapping potential to the second trapping potential and (ii) a duration of changing the second trapping potential to the first trapping potential are less than the trap period Tₜᵣₐₚ of the first trapped ion.

7. The method of claim 1, wherein the performing the first SDK comprises:
applying one or more first pairs of optical pulses to the first trapped ion, each pair of optical pulses including two counterpropagating pulses arriving at the first trapped ion, spectral components of the two counterpropagating pulses being separated by a frequency difference based on energy levels of the first spin state and the second spin state.

8. The method of claim 7, wherein the one or more first pairs of optical pulses include only one pair of optical pulses, and a respective pulse area of each optical pulse is π.

9. The method of claim 7, wherein the one or more first pairs of optical pulses include N0 pairs of optical pulses, and a respective pulse area of each optical pulse is π.

10. The method of claim 7, wherein the one or more first pairs of optical pulses include N0 pairs of optical pulses, and a total pulse area of N0 optical pulses in the respective N0 pairs of optical pulses is π.

11. The method of claim 7, wherein:
the first trapped ion is a Ytterbium (¹⁷¹Yb⁺) ion,
the first spin state and the second spin state correspond to two hyperfine levels |0> and |1> of a ²S_{1/2} ground manifold of the ¹⁷¹Yb⁺ ion, and
each pair of optical pulses drives a stimulated Raman transition between the two hyperfine levels |0> and |1>.

12. The method of claim 1, wherein the performing the first SDK comprises:
applying one or more optical pulses to the first trapped ion, each optical pulse resonantly driving the first trapped ion from the first spin state to the second spin state.

13. The method of claim 1, wherein the changing of the first trapping potential comprises manipulating voltages at electrodes of the ion trap.

14. The method of claim 1, further comprising:
performing a first SDK to a second trapped ion in the ion trap having the first trapping potential, the second trapped ion being in a first spin state and a first motional state prior to the first SDK to the second trapped ion, the first SDK to the second trapped ion including a first momentum kick to the second trapped ion that depends on the first spin state of the second trapped ion and is associated with a spin flip from the first spin state of the second trapped ion into a second spin state of the second trapped ion.

15. The method of claim 2, wherein the changing of the first trapping potential further comprises increasing a trapping frequency.

16. The method of claim 1, wherein the phase is dependent on a size of the first momentum kick and the changing of the first trapping potential to the second trapping potential, and the current spin state is one of the first spin state and the second spin state.

17. A quantum information processing (QIP) system, comprising:
an array of trapped ions including a first trapped ion;
an optical system configured to generate pairs of optical pulses;
an ion trap configured to trap the first trapped ion, a trapping potential of the ion trap being switchable between a first trapping potential and a second trapping potential; and
a controller for controlling operations of the optical system and the ion trap, the controller configured to:
control the optical system to perform a first state dependent kick (SDK) to the first trapped ion that is in a first spin state and a first motional state prior to the first SDK, the first SDK including a first momentum kick to the first trapped ion that depends on the first spin state and is associated with a spin flip from the first spin state into a second spin state, a duration of the first SDK being less than a trap period Tₜᵣₐₚ of the first trapped ion; and
switch the first trapping potential of the ion trap to the second trapping potential of the ion trap,
wherein a phase associated with a current spin state of the first trapped ion is amplified by changing the first trapping potential of the ion trap to the second trapping potential of the ion trap, the phase is dependent on a size of the first momentum kick and the changing of the first trapping potential to the second trapping potential, and the current spin state is one of the first spin state and the second spin state.

18. The QIP system of claim 17, wherein the controller is configured to: change a first equilibrium position c10 of the first trapped ion in the first trapping potential to a second equilibrium position c11 of the first trapped ion in the second trapping potential, the phase associated with the current spin state of the first trapped ion being amplified by a displacement between the first equilibrium position c10 and the second equilibrium position c11.

19. The QIP system of claim 17, wherein the controller is configured to, after switching the first trapping potential to the second trapping potential, control the optical system to perform a second SDK on the first trapped ion, the second SDK including a second momentum kick to the first trapped ion that is opposite to the first momentum kick and is associated with a spin flip from the second spin state into the first spin state, a duration of the second SDK being less than the trap period Tₜᵣₐₚ, a first delay T1 being between the first SDK and the changing of the first trapping potential, a second delay T2 being between the second SDK and the switching of the first trapping potential to the second trapping potential.

20. The QIP system of claim 19, wherein the controller is configured to control the second trapping potential of the ion trap being switched to the first trapping potential of the ion trap, a third delay T3 being between the second SDK and the changing of the second trapping potential.
